(19) United States
(12) Patent Application Publication
(10) Pub. No.: US 2007/0153364 A1
(43) Pub. Date: Jul. 5, 2007

(54) Tunable fiber amplifier and laser using discrete fundamental-mode cutoff

(75) Inventors: Sien Chi, Hsinchu City (TW); Nan-Kuang Chen, Xinzhuang City (TW)

Correspondence Address: TROXELL LAW OFFICE PLLC, SUITE 1404, 5205 LEESBURG PIKE, FALLS CHURCH, VA, 22041, US

(73) Assignee: National Chiao Tung University

(21) Appl. No.: 11/320,804

(22) Filed: Dec. 30, 2005

(51) Int. Cl. H01S 3/00; H04B 10/12

(52) U.S. Cl. 359/341.1; 359/333

(57) ABSTRACT

The present invention uses short-pass filters to suppress the optical gain in C-band of an Er-doped optical fiber by discrete fundamental-mode cutoff so that S-band with shorter wavelength can obtain enough optical gain for signal amplification.

### FIELD OF THE INVENTION

The present invention relates to a fiber amplifier; more particularly, relates to a tunable Er-doped optical fiber amplifier covering S-band and C-band and L-band.

### DESCRIPTION OF THE RELATED ARTS

A group of prior arts includes U.S. Pat. No. 6,909,538, “Fiber amplifiers with depressed cladding and their uses in Er-doped fiber amplifiers for the S-band”; U.S. Pat. No. 6,903,865,“Communication system using S-band Er-doped fiber amplifiers with depressed cladding”; U.S. Pat No. 6,844,962, “S-band light sources using erbium-doped fiber with depressed cladding”; M. A. Arbore, “Application of fundamental-mode cutoff for novel amplifiers and laser” in Proceedings of Optical Fiber Communication Conference OFC'05; and M. A. Arbore, et al, “S-band erbium-doped fiber amplifiers for WDM transmission between 1488 and 1508 nm,”in Proceedings of Optical Fiber Communication Conference OFC'03 (Optical Society of America, Washington, D.C., 2003), paper WK2. Regarding these prior arts, they obtain an Er-doped optical fiber amplifier for S-band through distributed fundamental-mode cutoff based on wave guide dispersion. The wavelengths longer than the fundamental-mode cutoff suffer from significant optical losses and the short wavelengths can thus achieve high population inversion and obtain enough gain. However, a waveguide dispersion uses a special optical fiber having depressed inner cladding so that the cost is higher and the fundamental-mode cutoff wavelength can only be mechanicaly tunable.

Another group of prior arts includes U.S. Pat. No. 6,924,928, “Amplification device utilizing thulium doped modified silicate optical fiber”; U.S. Pat. No. 6,797,657, “Tm-doped fluoro phosphate glasses for 14 xx amplifiers and lasers”; and S Shen, A. Jha, L. Huang, and P. Joshi, “980 nm diode-pumped Tm³⁺/Yb³⁺-codoped tellurite fiber for S-band amplification,” Opt. Lett. 30, 1437-1439 (2005). They use thulium material to obtain optical amplification in S-band and the thulium is doped in material with low phonon energy to obtain high gain efficiency. Yet material with low phonon energy is apt to be recrystalized to increase loss and special optical fiber is still required to be made costly. Hence, the prior arts do not fulfill users' requests on actual use.

### SUMMARY OF THE INVENTION

The main purpose of the present invention is to achieve a simple and cost-effective tunable Er-doped fiber amplifiers covering-S-band, C-band and L-band using Er-doped fiber having no depressed inner cladding while based on discrete fundamental-mode cutoff, where each fundamental-mode cutoff is a short-wavelength-pass filter itself and is achieved based on material dispersion discrepany between the optical polymers and the silica fiber.

To achieve the above purpose, the present invention is a tunable fiber amplifier and laser using discrete fundamental-mode cutoff, comprising an optical fiber with an input port and an output port; and filter, distributed with an interval to next filter, to obtain a fundamental-mode cutoff wavelength, where an optical fiber amplifier is obtained; and at least one resonance cavity can be added onto the optical fiber to obtain a laser.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a structural view showing a first preferred embodiment according to the present invention;

FIG. 2 is a structural view showing a filter of the preferred embodiment according to the present invention;

FIG. 3 is a view showing an ASE spectra of S-band and a C-band from a 25 cm optical fiber and a 150 cm optical fiber according to the present invention;

FIG. 4 is a structural view showing a second preferred embodiment according to the present invention;

FIG. 5 is a structural view showing a third preferred embodiment according to the present invention; and

FIG. 6 is a structural view showing a fourth preferred embodiment according to the present invention.

### DESCRIPTION OF THE PROFFERED EMBODIMENTS

The following descriptions of the preferred embodiments are provided to understand the features and the structures of the present invention.

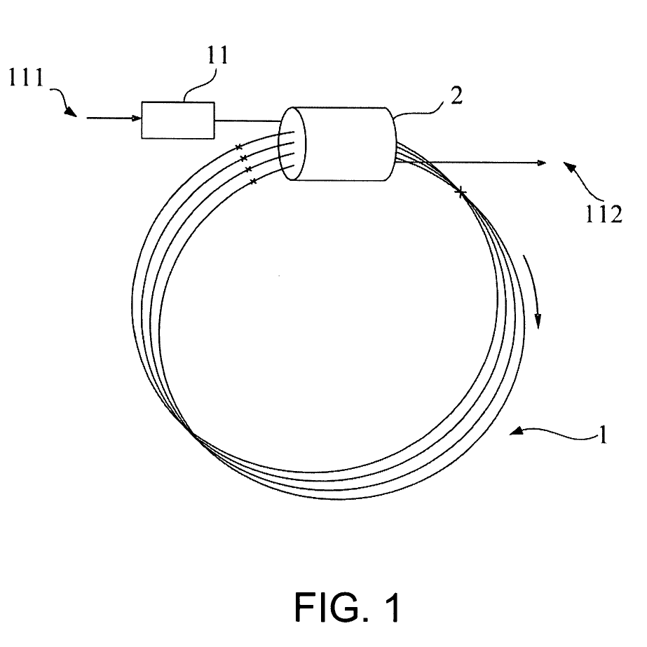

Please refer to FIG. 1, which is a structural view showing a first preferred embodiment according to the present invention. As shown in the figure, the present invention is a tunable fiber amplifier using discrete fundamental-mode cutoff, comprising an optical fiber 1 and a filter 2, where an optical gain in C-band of the optical fiber 1 is restrained by using discrete fundamental-mode cutoff so that S-band with shorter wavelength obtains enough optical gain to amplify signals.

The optical fiber 1 is an Er-doped fiber with an optical gain obtained by being doped with rare earth ion or by a non-linear effect. The optical fiber 1 comprises an input port 111 and an output port 112.

The filter 2 is a short-wavelength-pass filter, made of an optical fiber in a way of a side-polishing, a fused-tapering, a chemical etching or a laser ablation, where a filter is obtained by a material dispersion discrepancy between a polymer and a silica fiber. The filter 2 is located on the optical fiber 1 to produce a fundamental-mode cutoff wavelength, where, if there are more than one filter, a previous filter comprises an interval to a next filter 2; and the filter is further controlled by temperature or electromagnetic field (EMF) to decide the fundamental-mode cutoff wavelength In the same way, a tunable Raman fiber amplifier and laser can be made.

When using the present invention, the filter 2 is distributed on the optical fiber 1, where, if there are more than one filter, an interval is located between a previous filter and a next filter, and the filters can be gathered together to be fixed in a tube. At first, an optical signal source enters into an input port 111 of the optical fiber 1 through a wavelength-division-multiplexer 11. Then, a fundamental-mode cutoff wavelength is obtained by using the filter 2 to filter out the wavelengths longer than the cutoff. Consequently, by a character of the filter 2, short wavelengths in S-band can obtain enough optical gain for optical amplification and the fiber can guide and transmit the amplified S-band signals toward the output port 112 of the optical fiber 1. As a result, an optical amplifier for S-band is obtained by using a standard optical fiber having no depressed inner cladding Besides, the refractive index of the polymer can be tuned by temperature or EMF so that the optical amplifier is tunable between an amplifier for S-band and one for C-band.

However, the filter 2 can be a long-wavelength-pass filter, a band-pass filter or a band-rejection filter.

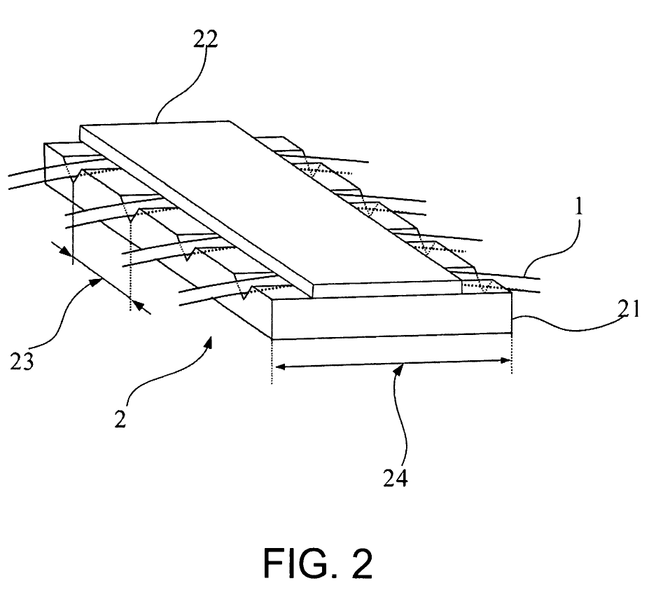

Please refer to FIG. 2, which is a structural view showing a filter of the preferred embodiment according to the present invention. As shown in the figure, a filter 2 using a silicon V-groove substrate 21 is fabricated in a way of a fiber side-polishing, a fused-tapering, a chemical etching or a laser ablation, covered with an optical polymer overlay 22. The filter 2 is used to filter the ASE (Amplified Spontaneous Emission) generated by the C-band of the Er/Yb co-doped optical fiber 1, where the spacing between fibers is 25 cm (millimeter) and the length of the filter 2 is 35 mm.

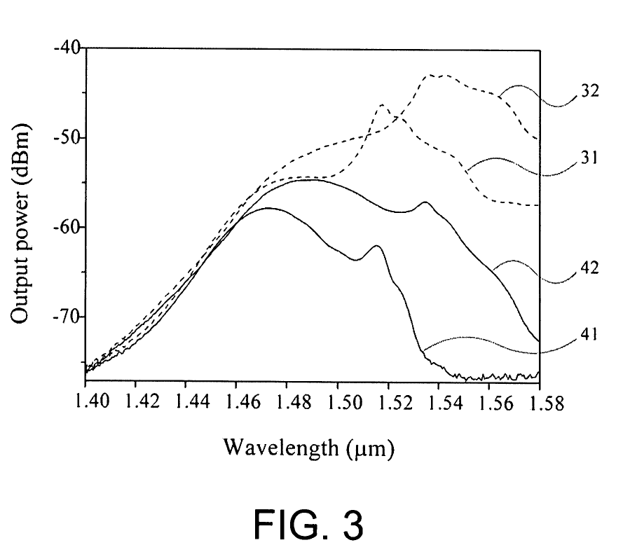

Please refer to FIG. 3, which is a view showing ASE spectra of a S-band and a C-band from a 25 cm optical fiber and a 150 cm optical fiber according to the present invention. As shown in the figure, a 25 cm of a high-concentration Er/Yb codoped fiber is processing a filtering with a short-wavelength-pass filter so that an original ASE spectrum curve 31 is moved toward S-band curve 4 having short wavelength. Therein, the power difference (0.68 dB) between the ASE spectrum curve 31 and the S-band curve 41 under a shorter wavelength (1460 mm) is smaller than that (16 dB) under a longer wavelength (1520 mm). Hence, by locating a short-wavelength-pass filter every 25 cm and connecting several high-concentration Er/Yb codoped fibers in a series, an optical amplifier for S-band is obtained. Nevertheless, by tuning the short-wave length-pass filter to make the wavelengths 32 in C-band be guided through the filter, wavelengths in C-band 42 are amplified too. Thus, a novel tunable fiber amplifier using discrete fundamental-mode cutoff is obtained.

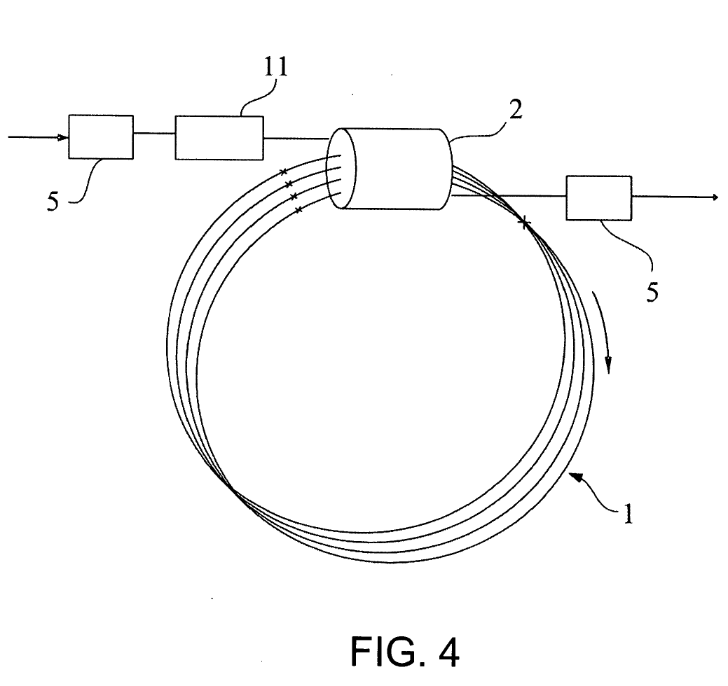

Please refer to FIG. 4, which is a structural view showing a second preferred embodiment according to the present invention. As shown in the figure, a resonant cavity 5 can be added onto an optical fiber amplifier 1 according to the present invention to obtain a laser, where the resonant cavity 5 can be formed by optical gratings, couplers, optical reflectors, photon crystals, micro-rings or dielectric thin films for better fulfill users' requests on actual use.

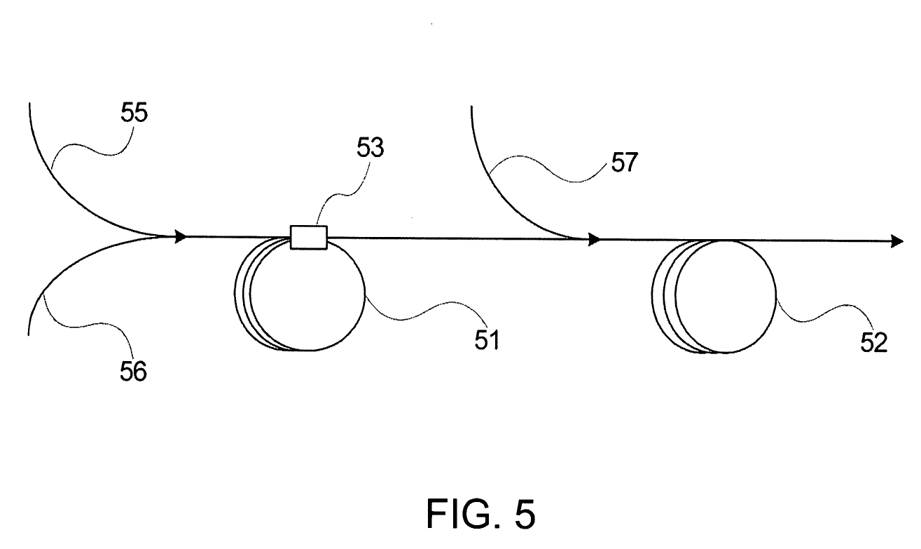

Please refer to FIG. 5, which is a structural view showing a third preferred embodiment according to the present invention. As shown in the figure, the present invention comprises a first and a second optical fibers 51, 52 and first filters 53. When using the present invention, the first filters 53 are distributed on the first optical fiber 51 and are gathered together to be fixed in a tube. At first, S-band signals 54 with a pumping light 55 enter into the first optical fiber 51. Fundamental-mode cutoff wavelengths are obtained by using the first filters 53 so that wavelengths in S-band obtain enough optical gain. And, then, the amplified S-band signals 54 together with C-band signals 56 are outputted through the second optical fiber 52. As a result, an optical amplifier for S-band signals and C-band signals is obtained by using a standard optical fiber having no depressed inner cladding.

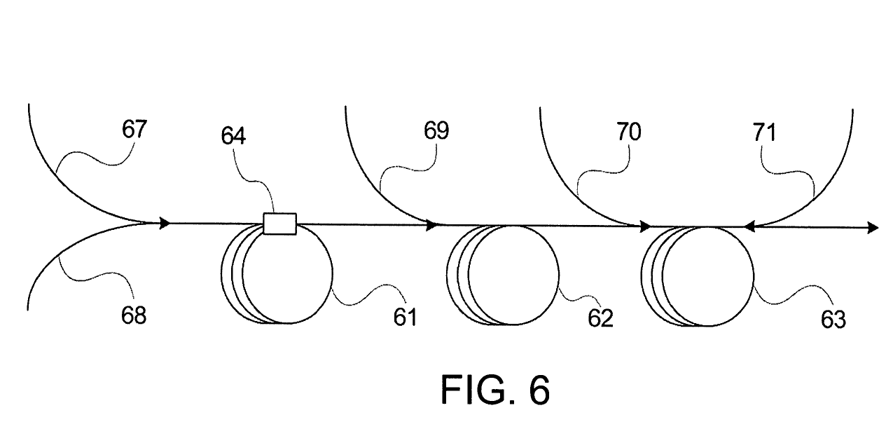

Please refer to FIG. 6, which is a structural view showing a fourth preferred embodiment according to the present invention. As shown in the figure, the present invention comprises a fourth, a fifth and a sixth optical fibers 61, 62, 63 and second filters 64. When using the present invention, the second filters 64 are distributed on the fourth optical fiber 61 and are gathered together to be fixed in a tube. At first, S-band signals 65 with a forward pumping light 66 enter into the first optical fiber 61. Wavelengths in S-band with the S-band signals 65 obtain enough optical gain through the second filters 64. Then, the signals transmitted out from the first optical fiber 61 is added with C-band signals 67 to enter the second optical fiber 62; the signals transmitted out from the second optical fiber 62 is added with L-band signals 68 to enter the third optical fiber 63; and, a backward pumping light 69 is added to the signals transmitted out from the third optical fiber 63. In the end, the amplified S-band signals 66 together with C-band signals 67 and L-band signals 68 are outputted through the third optical fiber 63. As a result, an optical amplifier for S-band signals, C-band signals and L-band signals is obtained by using a standard optical fiber having no depressed inner cladding.

To sum up, the present invention is a tunable fiber amplifier and laser using discrete fundamental-mode cutoff. A short-wave length-pass filter is obtained by a material dispersion discrepany between a polymer and a silica fiber. Filter is distributed with an interval between a previous filter and a next filter so that an Er-doped optical fiber amplifier for S-band is obtained with the discrete fundamental-mode cutoff. Nevertheless, when the temperature goes down, the fundamental-mode cutoff wavelength goes down accordingly and an optical gain is obtained in S-band with the Er-doped optical fiber. When the temperature raises up, the fundamental-mode cutoff wavelength raises up accordingly and an optical gain is obtained in C-band with the Er-doped optical fiber. By doing so, a simple and cost-effective Er-doped optical fiber amplifier covering S-band and C-band and L-band is obtained, where the discrete fundamental-mode cutoff is obtained with a filter based on a fused-tapering, a fiber side-polishing, a chemical etching or a laser ablation technique. In the same way, a simple and cost-effective Er-doped optical fiber amplifier covering S-band, C-band and L-band can be obtained through discrete fundamental-mode cutoff.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A tunable fiber amplifier using discrete fundamental-mode cutoff, comprising:
(a) at least one optical fiber comprising an input port and an output port; and
(b) at least one filter located on said optical fiber to obtain a fundamental-mode cutoff wavelength, said filter having an interval to another said filter.

2. The fiber amplifier according to claim 1, wherein said optical fiber is an Er-doped optical fiber.

3. The fiber amplifier according to claim 1, wherein said optical fiber comprises an optical gain obtained by a way selected from a group consisting of being doped with rare earth ion and having non-linear effect.

4. The fiber amplifier according to claim 1, wherein said filter is a short-wavelength-pass filter.

5. The fiber amplifier according to claim 1, wherein said filter is a long-wavelength-pass filter.

6. The fiber amplifier according to claim 1, wherein said filter is a band-pass filter.

7. The fiber amplifier according to claim 1, wherein said filter is a band-rejection filter.

8. The fiber amplifier according to claim 1, wherein said filter is made in a way selected from a group consisting of a fiber side-polishing, a fused-tapering, a chemical etching and a laser ablation.

9. The fiber amplifier according to claim 1, wherein said filter is further controlled to tune a mental-mode cutoff wavelength by a factor selected from a group consisting of temperature and electromagnetic field (EMF).

10. A tunable laser using discrete fundamental-mode cutoff, comprising:
(a) at least one optical fiber comprising an input port and an output port;
(b) at least one filter located on said optical fiber to obtain a fundamental-mode cutoff wavelength, said filter having an interval to another said filter;
(c) at least one resonant cavity located on said optical fiber.

11. The fiber amplifier according to claim 10, wherein said optical fiber is an Er-doped optical fiber.

12. The fiber amplifier according to claim 10, wherein said optical fiber comprises an optical gain obtained by a way selected from a group consisting of being doped with rare earth ion and having non-linear effect.

13. The fiber amplifier according to claim 10, wherein said filter is a short-wave length-pass filter.

14. The fiber amplifier according to claim 10, wherein said filter is a long-wavelength-pass filter.

15. The fiber amplifier according to claim 10, wherein said filter is a band-pass filter.

16. The fiber amplifier according to claim 10, wherein said filter is a band-rejection filter.

17. The fiber amplifier according to claim 10, wherein said filter is made in a way selected from a group consisting of a fiber side-polishing, a fused-tapering, a chemical etching and a laser ablation.

18. The laser according to claim 10 wherein said resonant cavity is selected from a group consisting of an optical grating, a coupler, an optical reflector, a photon crystal, a micro-ring and a dielectric thin film.

19. The fiber amplifier according to claim 10, wherein said filter is further controlled to tune the fundamental-mode cutoff wavelength by a factor selected from a group consisting of temperature and EMF.
